(19) United States
(12) Patent Application Publication
(10) Pub. No.: US 2026/0340052 A1
(43) Pub. Date: Oct. 29, 2026

(54) DYNAMIC DEPTH-OF-FIELD FOCUS IN AUTOMOTIVE ENVIRONMENTS

(71) Applicant: Reveal Innovations, LLC, Santa Clara, CA (US)

(72) Inventors: Thomas YAMASAKI, Anaheim Hills, CA (US); Koichiro KANDA, San Jose, CA (US)

(73) Assignee: Reveal Innovations, LLC, Santa Clara, CA (US)

(21) Appl. No.: 19/661,149

(22) Filed: Apr. 28, 2026

Related U.S. Application Data
(60) Provisional application No. 63/796,101, filed on Apr. 28, 2025.

(51) Int. Cl. G06F 16/9535; G01C 21/36; G06F 3/01; G06F 40/284; G06F 40/40; G10L 15/08; G10L 15/183; G10L 15/22; G10L 15/30; G10L 21/0216

(52) U.S. Cl. CPC G06F 16/9535; G06F 3/013; G06F 40/284; G06F 40/40; G10L 15/183; G10L 15/22; G10L 15/30; G10L 21/0216; G01C 21/3679; G10L 2015/088

(57) ABSTRACT

Methods and systems for using a dynamic depth-of-field focus to enhance a passenger experience in non-, partially-, or fully-autonomous vehicles are described. An example method includes receiving a trigger word uttered by a designated passenger and receiving data from within a cabin of the vehicle. The method further includes determining, subsequent to receiving the trigger word and based on the data, a point of interest indicated by the designated passenger and a request associated with the point of interest. The method further includes determining, based on the request, information related to the point of interest, and providing the information to the designated passenger. An example system includes one or more processors configured to identify the point of interest by correlating cabin data with vehicle movement data.

### RELATED APPLICATIONS

This application claims the benefit of U.S. Provisional Application No. 63/796,101 filed on Apr. 28, 2025, the entirety of which is incorporated herein by reference.

### TECHNICAL FIELD

This document generally relates to systems, devices and processes that enhance the passenger experience in non-, partially- and/or fully-autonomous vehicles.

### BACKGROUND

Vehicles are currently equipped with a variety of input and output devices that support increasingly automated driving functions. These systems, however, are not generally configured to help passengers safely and intuitively interact with objects, locations, or points of interest outside the vehicle. A dynamic depth-of-field focus system may be used to identify a point of interest indicated by a passenger in or around a vehicle and provide contextually relevant information while accounting for vehicle state, passenger intent, and safety conditions.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 shows an example of an embedded system in a vehicle, according to an implementation of the disclosure.

FIG. 2 shows an example of a non-embedded system in the vehicle, according to an implementation of the disclosure.

FIG. 3 shows an example of various modules and services available to the embedded system of the vehicle when implementing the described methods and processes, according to an implementation of the disclosure.

FIG. 4 shows an example of a non-embedded subsystem, e.g., a user device, according to an implementation of the disclosure.

FIG. 5 shows an example flow diagram for achieving a dynamic depth-of-field focus.

FIG. 6 shows an example of determining a gaze vector of a designated vehicle occupant, such as a designated passenger, in a vehicle, according to an implementation of the disclosure.

FIG. 7 shows a flow diagram for determining user intent, according to an implementation of the disclosure.

Described herein are systems and methods for dynamically identifying a point of interest indicated by a designated vehicle occupant, such as a designated passenger, and providing contextually relevant information associated with the point of interest. The system receives a trigger input, such as a trigger word, collects cabin data associated with the designated vehicle occupant, and correlates the cabin data with vehicle movement data to dynamically narrow candidate points of interest. The cabin data may include gaze direction, facial orientation, gesture trajectory, speech input, changes in gaze direction, changes in gesture trajectory, or other occupant intent signals. The vehicle movement data may include vehicle location, trajectory, speed, orientation, route information, or other vehicle-state information. Based on these inputs, the system identifies a point of interest, determines a request associated with the point of interest, retrieves information from a point of interest database, a third-party service, or a remote computing platform, and provides the information to the designated vehicle occupant through a vehicle output device or a user device. In some embodiments, a disambiguation module uses additional cabin data, feedback, facial expression, speech, voice stress, or confidence information to resolve ambiguity regarding the point of interest or the associated request. Additional features, objects, and advantages will be apparent to one skilled in the art upon examination of the following description, drawings examples, and claims. It is intended that all such additional systems, methods, features, and advantages be included within this description, be within the scope of the present disclosure, and be protected by the accompanying claims.

### DETAILED DESCRIPTION

The transportation industry has been undergoing considerable changes in the way technology is used to control the operation of the vehicles. As exemplified in the automotive passenger vehicle, there has been a general advancement towards shifting more of the operational and navigational decision making away from the human driving and into on-board computing power. This is exemplified in the extreme by the numerous under-development autonomous vehicles. Current implementations are in intermediate stages, such as the partially-autonomous operation in some vehicles (e.g., autonomous acceleration and navigation, but with the requirement of a present and attentive driver), the safety-protecting operation of some vehicles (e.g., maintaining a safe following distance and automatic braking), the safety-protecting warnings of some vehicles (e.g., blind-spot indicators in side-view mirrors and proximity sensors), as well as ease-of-use operations (e.g., autonomous parallel parking).

The move towards autonomous operation of vehicles has also resulted in a change in how users interact with the vehicles themselves. For example, in fully autonomous vehicles, the “driver” may be free to conduct any number of activities not typically possible (e.g., reading a book, watching a movie, looking at a passenger with whom he is engaged in conversation).

Embodiments of the disclosed technology are based on the recognition that the move towards autonomous operation of vehicles also has the ability to change the way in which the passengers interact with the environment around the vehicle. Passengers may be able to dwell longer on things seen in the surrounding landscape (e.g., a picturesque view of the ocean or architectural elements of buildings) or even engage with other drivers and social media applications in slow traffic.

But this opportunity also presents technological and safety challenges.

First, even if the passenger has an interest in more fully engaging with a surrounding environment, present technology does not generally support such interactions. Because traditional automobiles were designed around the premise that the driver is focused on the road and the non-driver passengers are primarily interested in being comfortable inside the cabin, there is relatively little technological infrastructure supporting a passenger's desire to engage with the external environment.

Second, passengers' interest in interacting with the environment outside the vehicle presents a safety concern. Namely, while such interactions may well be beneficial in fully autonomous vehicles, the same interactions (e.g., gazing at length at a picturesque landscape) may be extremely hazardous in vehicles that are not autonomous or only partially autonomous. And it is unlikely that the entire automotive industry will undergo a single, sudden change over from non-autonomous to fully autonomous vehicles. Thus, a safety problem arises as users themselves alternate between different vehicles with different levels of autonomous operation (e.g., the person's fully autonomous car, the person's spouse's partially autonomous car, a non-autonomous rental car, a friend's non-autonomous car, etc.). Namely, a user that has adopted social behaviors of greater interaction with external environments that are possible and desirable in an autonomous vehicle may not abandon those same behaviors when driving a non-autonomous vehicle, thereby potentially endangering himself, other passengers in the vehicle, pedestrians, and passengers in other vehicles. It should not be underestimated the way in which minor changes in vehicle environments can cause significant driver confusion. There have been numerous reports of crashes and deaths due to “unintended acceleration” when a driver operated an unfamiliar vehicle, with the ultimate cause being that the driver was unaccustomed to the position of the pedals and inadvertently engaged the accelerator instead of the brake. Thus, minor variations in vehicle environments have the possibility to introduce significant safety risks.

And such variations are likely to increase in the future. Even as autonomous automobiles become commercially viable, it is unlikely that the entire automotive market will make a single, sudden shift to autonomous vehicles. Due to considerations of price, user preference, and other factors, it is likely that the new car market in the coming years will consist of a mixture of different levels of non-, partial-, and fully-autonomous vehicles. Adding to that the existing heterogenous mix of vehicles already on the road, it is likely that drivers in the future will encounter many different types of vehicle operations. And for the reasons described above, this has the potential to introduce significant safety concerns.

Thus, for both technological and safety reasons, the inventors recognize the need for advancements in vehicle technology relating to passenger's interaction with the environment outside the vehicle.

Embodiments of the disclosed technology are directed to systems and methods for elevating the passenger experience within a vehicle through the incorporation of dynamic depth-of-field focus and real-time processing of user interactions. The described system comprises both embedded and non-embedded subsystems, and seamlessly integrates with remote servers for third-party services, such as large language model (LLM) integration, e.g., ChatGPT, Claude, Llama and/or Gemini. The described methods encompass the reception of a designated trigger word from a passenger, and collecting comprehensive data from the vehicle's cabin environment. Then, the method determines points of interest (POI) by analyzing user gestures, gaze vectors, and vehicle movement data. The system processes user queries, searches a POI database, and delivers pertinent information through vehicle displays or user devices. Furthermore, an embedded disambiguation module enhances the system's ability to clarify user intent and manages ambient noise for optimal performance.

As used herein, “dynamic depth-of-field focus” refers to a computer-implemented process for dynamically narrowing a set of candidate points of interest based on multimodal vehicle and passenger context. The process does not require optical refocusing of a camera lens. Rather, the system identifies a relevant external or internal point of interest by correlating cabin data, such as gaze direction, head orientation, gesture trajectory, speech, trigger timing, and passenger identity, with vehicle movement data, such as location, trajectory, and speed. The system may then use the narrowed candidate set to perform a database search, large language model inference, third-party service query, or disambiguation operation. In this manner, the dynamic depth-of-field focus operates as a technical filtering and inference process that reduces ambiguity in identifying what the passenger is referencing.

As used herein, a “designated vehicle occupant” may include a driver, a designated passenger, e.g., a front-seat passenger, a rear-seat passenger, or another person within the cabin of the vehicle who is selected by the system as the source of a trigger, gesture, gaze vector, speech input, or other user intent signal. In some embodiments, the designated vehicle occupant is a non-driver passenger. In other embodiments, the designated vehicle occupant is the driver, such as when the vehicle is operating in an autonomous mode, semi-autonomous mode, parked mode, stopped mode, or another mode in which presenting point-of-interest information does not interfere with safe vehicle operation.

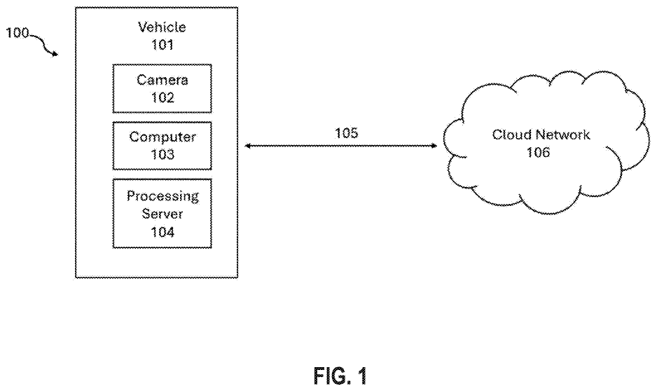

FIG. 1 illustrates an example system 100 that enhances the passenger experience through embedded hardware and cloud connectivity. As shown therein, the example system includes a vehicle 101 with an embedded system that includes a camera 102, a computer 103, and a processing server 104. These components collectively enable the vehicle to perform operations that include data capture, local processing, and execution of both training and inference operations for various artificial intelligence (AI) models.

In some embodiments, the camera captures real-time visual data from both within the vehicle and the vehicle's surroundings, which is then processed by the computer. The computer 103, acting as an onboard computing platform, manages and processes this data for evaluation and further processing by the processing server 104 or a server in the cloud network 106, e.g., Amazon Web Services or Azure. The processing server 104 within the vehicle is designed to perform advanced computational tasks, including the training and deployment (inference) of AI models that the system relies on. This local processing capability ensures responsiveness and real-time performance for critical applications. In some embodiments, the computer 103 and/or processing server 104 may be omitted. In such embodiments, processing activities described in this disclosure may instead be performed by one or more computers or servers in cloud network 106.

In some embodiments, the vehicle 101 maintains a connection to the cloud network 106 through a data link 105, such as the Internet. This cloud connection allows for extended data processing, greater storage capabilities, and access to additional cloud-based services, essentially combining the vehicle's local computing strengths with the expansive resources and services available on the cloud.

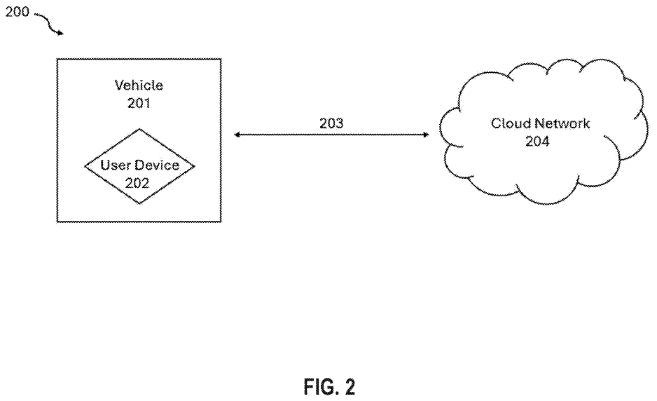

FIG. 2 shows an example system 200 in which the non-embedded components are highlighted. As shown therein, the vehicle 201 includes a user device 202, which interacts with one or more components of the embedded system described in FIG. 1. In some embodiments, the user device 202 can be leveraged by a component of the embedded system to perform data reception, processing, and transmission. As in the case of FIG. 1, the non-embedded system in the vehicle 201 maintains a connection to the cloud network 204 through a data link 203.

The systems 100 and 200 may include alternative configuration according to various embodiments of the present disclosure.

For example, in some embodiments, the user device 202 may include a user wearable device, such as sunglasses, corrective lenses, a virtual reality headset, an augmented reality headset, or other similar devices.

In such embodiments, the cameras described in this disclosure may include one or more cameras included in the user wearable device. Further in such embodiments, the processing activities described in this disclosure may be performed by one or more processors embedded in the user wearable device. Further in such embodiments, the communications to a remote server, cloud network, etc. described in this disclosure may include use of one or more communication modules embedded in the user wearable device (e.g., Bluetooth transceiver, Wi-Fi transceiver, cellular network transceiver). Further in such embodiments, the user wearable device may interact with a computer (e.g., computer 103) embedded in the vehicle 201 in order to perform processing and/or communications activities described in this disclosure. Alternatively, the user wearable device may perform the activities described in this disclosure in a vehicle (e.g., vehicle 201) where no embedded devices are present (e.g., no camera 102, computer 103, or processing server 104).

As another example, in some embodiments, the user device 202 may include a user portable device such as a smartphone, a tablet computer, or other similar devices. In such embodiments, the cameras described in this disclosure may include one or more cameras included in the user portable device. Further in such embodiments, the processing activities described in this disclosure may be performed by one or more processors embedded in the user portable device. Further in such embodiments, the communications to a remote server, cloud network, etc. described in this disclosure may include use of one or more communication modules embedded in the user portable device (e.g., Bluetooth transceiver, Wi-Fi transceiver, cellular network transceiver). Further in such embodiments, the user portable device may interact with a computer (e.g., computer 103) embedded in the vehicle 201 in order to perform processing and/or communications activities described in this disclosure. Alternatively, the user portable device may perform the activities described in this disclosure in a vehicle (e.g., vehicle 201) where no embedded devices are present (e.g., no camera 102, computer 103, or processing server 104).

In some embodiments, the user device 202 may be placed in the vehicle in an arrangement suitable to perform the activities described in this disclosure. For example, where the user device 202 is a smartphone, the user device 202 may be mounted in a position suitable to perform the activities described in this disclosure. For instance, the user device 202 may be mounted upright on or around the dashboard of the vehicle 201. In this arrangement, the user device 202 may be positioned so that a front facing camera of the user device 202 is capable of capturing images of the interior of the vehicle 201 (e.g., images of the driver, images of the front seat passenger, etc.). Further in this arrangement, the user device 202 may be positioned so that a rear facing camera of the user device 202 is capable of capturing images of the exterior of the vehicle 201 (e.g., images captured through the windshield, images of the roadway in front of the vehicle 201, images of the environment around the vehicle 201, images of storefronts along the road that the vehicle 201 is traveling on, etc.). In this way, the user device 202 may be positioned in the vehicle 201 so that the user device 202 is configured to perform the activities of the present disclosure that occur within the vehicle 201. In such an arrangement, the present disclosure may be performed without the need for the use of embedded devices in the vehicle (e.g., without an embedded camera, without an embedded computer, without an embedded processing server, etc.).

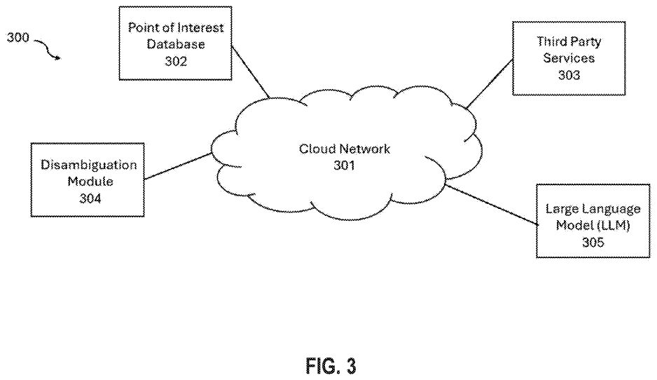

FIG. 3 shows various external systems, applications, and modules that can be leveraged by the vehicle through the cloud network 301 to enhance the passenger experience. As shown therein, the external systems include a point of interest database 302, third-party services 303, a disambiguation module 304, and a large language model (LLM) 305.

In some embodiments, the Point of Interest (POI) database 302 acts as a comprehensive repository of detailed information about user-centric locations within a geographic region, such as landmarks, businesses, and other relevant sites. In an example, this database includes location-based information and recommendations, encompassing data like geographical coordinates, business hours, reviews, and types of good and/or services offered. As further described, the POI database enables the generation of detailed, contextually-relevant responses to users' specific location-related queries. For example, the POI database 302 enables passengers to ask for nearby attractions or services, such as “Find me a gas station within 5 miles,” and receive detailed information about nearby options, including directions and reviews.

In some embodiments, the third-party services 303 represent external resources accessed through APIs and data feeds provided by third-party entities. In some examples, these services augment the system's capabilities and user interactivity, potentially including real-time information such as weather updates, traffic conditions, reservation booking systems, and payment gateways. The integration of third-party services ensures that the system can draw on a broad array of additional functionalities to enhance and expand its service offering. For example, the third-party services 303 enable passengers to utilize services like booking reservations, purchasing tickets, or accessing real-time traffic information. For instance, a passenger can say, “Book me a ticket for the next movie showing at the nearest cinema,” and the system will handle the reservation process using third-party services.

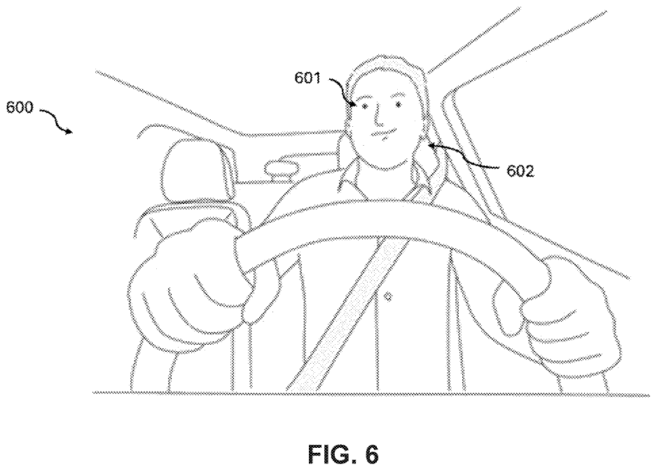

In some embodiments, the disambiguation module 304 ensures clarity and accuracy by resolving potential ambiguities in user queries and data inputs. In some examples, it handles multiple possible meanings or interpretations by analyzing context and refining search results or responses. In other examples, it requests feedback from a passenger upon determining that the passenger reacted negatively (e.g., frustration or annoyance) to the results presented, and refines those results by incorporating additional data gathered from the cabin of the vehicle. By clarifying ambiguous inputs and comprehensively interpreting user intent, the disambiguation module significantly improves the precision and relevance of the system's outputs. For example, the disambiguation module 304 improves query accuracy. For instance, if a passenger asks, “Find the nearest store,” the module can clarify whether the passenger wants a grocery store or a convenience store, ensuring precise results. For another example, the disambiguation module 304 is based on proximity, i.e., determining a gaze vector (e.g., as described in the context of FIG. 6) and then applying a proximity filter. For instance, after the gaze vector has been determined for a passenger, a point of interest (or store) from a range of POIs (or stores) that are coincident with the gaze vector is selected instead of choosing a POI or store that is on the opposite side of the vehicle or behind the vehicle, both options being inconsistent with the determined gaze vector.

In some embodiments, the large language model (LLM) 305 is an advanced AI-driven component dedicated to natural language processing (NLP). In some examples, this model interprets user inputs, processes queries, generates responses, and performs NLP tasks such as text tokenization, sentiment analysis, and understanding context. The LLM advantageously enhances communication between the system and passengers, offering an intuitive, responsive, and context-aware interaction experience. The LLM 305 enables passengers to naturally interact with the system. An example would be a passenger asking, “Can you suggest a good Italian restaurant nearby?” and receiving suggestions with descriptions, menus, and user ratings.

As shown in FIG. 3, the various systems interconnected via the cloud network 301 provide a seamless and responsive experience, ensuring passengers receive accurate, timely, and relevant information and services, thereby substantially improving their travel experience. For example, while traveling, a passenger inquires, “What's a good place to eat around here?” In response, the system (e.g., in vehicle 101 or 201) accesses the POI database 302 for restaurants, consults third-party services 303 for current reviews and availability, uses the disambiguation module 304 to ensure clarity, and processes the query through the LLM 305 for context understanding. This results in a precise recommendation delivered seamlessly.

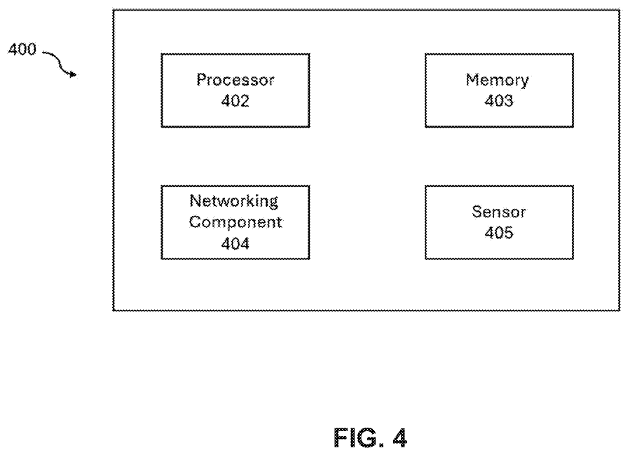

FIG. 4 shows an example of a non-embedded system 400, e.g., a user device, that can be configured to implement the methods and embodiments described in this patent document. As shown therein, the user device 400 includes a processor 402, a memory 403, a networking component 404, and a sensor 405. In some examples, the processor 402 includes one or more processors that are configured to interact with the memory 403 to implement the described methods and processes. The networking component 404 can be leveraged to communicate with components of the embedded system in the vehicle and/or the cloud network. The sensor 405 includes a camera, microphone, etc., and which can be used to provide additional information regarding user intent.

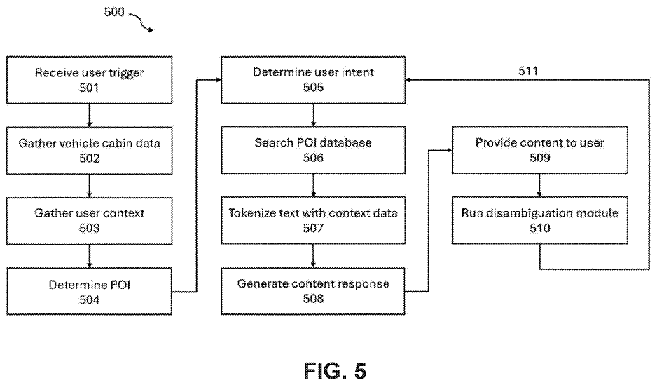

FIG. 5 shows an example flow diagram for a method 500 performed in a vehicle, which includes operations 501-511, each of which are described below. Each operation in FIG. 5 is also described in the context of real-world example of a passenger looking for a coffee shop.

The process begins with receiving a user trigger 501, and detecting an initial user action or command, which serves as the trigger to initiate the system's response. In some examples, the trigger can awaken one or more modules that were previously operating in a power-saving mode. In some examples, the user trigger could be in the form of a hotword (e.g., “Hey Car”), a wakeword (specific command phrases), or a physical gesture (such as a hand movement, e.g., as described in the context of FIGS. 5A and 5B in U.S. Pat. No. 11,900,672, which is incorporated, in its entirety, as part of this patent document). In the real-world example, a passenger says, “Hey car, find me a coffee shop.”

Once the trigger is received, the system collects relevant data from within the vehicle's cabin 502. In some examples, this data gathering encompasses the user's gaze vector, finger trajectory, additional spoken words beyond the hotword, and any other contextual data detected within the cabin. In some examples, the relevant data is collected using a microphone system (e.g., as described in U.S. Pat. No. 10,854,202, which is incorporated, in its entirety, as part of this patent document). In the real-world example, the system detects that the user is pointing towards the navigation screen and continues to collect spoken inputs like “nearest Starbucks.”

In some embodiments, receiving the user trigger 501 and receiving the data from the cabin of the vehicle 502 are performed in conjunction with signal processing methods that reduce any interfering signals. For example, the interfering signal can be from podcasts or audiobooks being played on the infotainment system, or speech by a passenger who is not the designated passenger. In some examples, the signal processing methods include filtering techniques, e.g., as described in the context of FIG. 3B in U.S. Pat. No. 10,854,202.

Simultaneously, the system retrieves contextual information about the user 503. In some examples, this includes user preferences, habits, past interactions, and current activities, providing a deeper understanding of the user's immediate needs and history. In the real-world example, the system recognizes that the user often searches for coffee shops around this time of day and prefers Starbucks.

With the gathered data, the system identifies the Point of Interest (POI) 504. In some examples, and as described earlier, the vehicular system can interact with a cloud network to identify the POI. In some examples, factors like the vehicle's current location, trajectory, speed, along with the user's gaze and gestures, help pinpoint the relevant POIs. The system may also apply filters based on contextual user preferences. In the real-world example, the system identifies several nearby coffee shops, prioritizing Starbucks locations based on user preference.

In some embodiments, when multiple candidate points of interest are located near one another, the system may distinguish among adjacent storefronts or other adjacent physical locations using storefront information and physical boundary information. For example, a point-of-interest database, map database, image-recognition service, or third-party service may store or provide storefront information including store names, street addresses, suite numbers, entrance locations, facade locations, sign locations, window locations, building frontage dimensions, or geographic coordinates associated with each storefront. The system may further identify vertical physical delineations between adjacent storefronts, such as walls, columns, door frames, window boundaries, signage boundaries, facade seams, or other vertical features that separate neighboring stores. The system may correlate the designated vehicle occupant's gaze vector, gesture trajectory, vehicle location, vehicle trajectory, and vehicle speed with the storefront information and vertical physical delineations to determine which of the adjacent storefronts is being indicated. For instance, when a gaze vector intersects a row of adjacent storefronts, the system may select the storefront whose facade region or entrance region falls within the gaze vector and may exclude neighboring storefronts separated by the identified vertical physical delineations.

In some embodiments, the contextual user preferences can be further biased based on hierarchical criteria. For example, based on previous user behavior, social media (e.g., TikTok, Instagram, Facebook, Linkedin, etc.) content posted by the user, social media content that the user follows, and/or explicit user feedback, a hierarchy of context factors can be used to select the relevant POIs. For instance, the context factors can include, but are not limited to, brand image (e.g., trendy or luxury brands), time context (e.g., afternoon, evening, or late night), and demographics (e.g., age, gender, marital status, income level). Herein, the context factors can be ranked for users or passengers (with different context factors and rankings being used for each user or passenger), and can then be applied to pinpoint the relevant POI.

For example, if the passenger frequently posts about or follows content related to trendy or luxury brands on social media platforms, the system can prioritize recommendations for high-end or popular establishments, which ensures that the suggestions align with the user's social media persona and interests, enhancing the relevance and appeal of the recommendations. For instance, if the user often engages with content about high-end coffee shops, the system might prioritize suggesting a trendy cafe over a standard coffee shop.

For another example, the system uses the time of day and demographic information to further refine recommendations. For example, if the user is a young professional and it is lunchtime on a weekday, the system might prioritize suggesting quick, trendy lunch spots that are popular among the working demographic. Conversely, if it is a weekend evening, the system might suggest more relaxed, social venues like bars or restaurants that are popular for evening outings. This hierarchical criterion ensures that the recommendations are not only based on user preferences but are also contextually appropriate for the time and the user's demographic profile.

Continuing with FIG. 5, the system then analyzes the accumulated data to ascertain the user's intent 505. By considering vehicle data, user context, and cabin inputs, it accurately interprets what the user aims to achieve. In some examples, the cabin inputs that are used to determine user intent include speech and in-cabin images obtained in time windows both before and after the trigger word was uttered. Here, there can be different durations for pre- and post-trigger time windows in which the cabin inputs are collected. In the real-world example, the system determines that the user intends to find and navigate to the nearest Starbucks.

Next, the system searches a dedicated database containing information about various POIs 506. It processes the user's request to locate specific POIs based on the identified intent and context. Examples of searching the POI database are further detailed in U.S. Pat. No. 11,900,672. In the real-world example, the database search yields several Starbucks locations within a 5-mile radius.

The system then tokenizes 507 the user's input, segmenting it into manageable units for processing. These tokens can represent words, phrases, or even individual characters, depending on the granularity required for the task. Furthermore, incorporating context data helps ensure accurate interpretation of these tokens. In the real-world example, the phrase “nearest Starbucks” is broken down and analyzed within the contextual framework of user preferences and current location. Herein, with contextual tokenization, the system uses context (e.g., the user's location and preference for Starbucks) to potentially group “nearest Starbucks” as a meaningful unit (instead of separate and disparate words), enhancing the search for nearby POIs fitting the user's known preferences.

Utilizing the tokenized text and context data, the system generates a content response 508. In some examples, this might include detailed POI information, e.g., reviews, operating hours, or other user-specific data. In some examples, the content response is generated from the POI database. In some examples, other third-party services can be leveraged to generate the content response. In the real-world example, the system provides the user with details such as the address, operating hours, and current crowd level at the nearest Starbucks.

The generated content is then presented to the user 509 through various interfaces such as the vehicle's display, a connected smartphone, or an auditory response using text-to-speech technology. In some examples, the vehicle's speed can be used to present an appropriate amount of information to the passenger. For example, when the vehicle is moving at high speed, only a few POIs are displayed (and would likely be more spaced out), whereas when the vehicle is moving more slowly, an increased number of POIs can be displayed to the passenger. In the real-world example, the vehicle's infotainment system displays the nearest Starbucks locations along with the generated information, and also reads it out loud to the user.

To resolve any potential ambiguities or misunderstandings, the system runs a disambiguation module 510. This module uses additional inputs like voice stress, facial expressions, and user feedback to ensure the response aligns accurately with user intent. To this end, the process includes a feedback loop 511 from the disambiguation module back to determining user intent. This iterative loop allows the system to refine and enhance the accuracy and relevance of its responses continuously. In the real-world example, if the user responds with, “No, the other Starbucks,” the system adjusts its response, providing directions to a different identified Starbucks location.

In some embodiments, the point of interest database 302 and/or third-party services 303 store or provide point-of-interest content that is used to generate information for presentation to the designated vehicle occupant. The point-of-interest content may include business hours, holiday hours, current operating status, reviews, ratings, menus, product listings, service listings, pricing information, discount information, inventory information, appointment availability, reservation availability, wait times, event times, ticket availability, accessibility information, parking information, or other information associated with the identified point of interest.

In some embodiments, the system selects which point-of-interest content to present based on the request associated with the point of interest. For example, if the designated vehicle occupant asks, “What do they serve there?” the system may retrieve and present a menu or list of services associated with the point of interest. If the designated vehicle occupant asks, “How expensive is it?” the system may retrieve and present price ranges, item-level pricing, service pricing, or other pricing information. If the designated vehicle occupant asks, “Are they open?” or “Can we get in now?” the system may retrieve and present current hours, reservation availability, wait time, appointment availability, ticket availability, or inventory availability.

In some embodiments, the system combines information from the point of interest database 302 with real-time or near-real-time information from third-party services 303. For example, the system may identify a restaurant as the point of interest based on a gaze vector and then retrieve the restaurant's hours, reviews, menu, pricing information, reservation availability, and current wait time before providing a response through a vehicle display, a user device, or an audio output.

FIG. 6 shows an example of using an embedded camera, a camera of a user device, or another cabin-facing sensor to analyze a gaze and facial orientation of a designated vehicle occupant to determine a point of interest. In some embodiments, the designated vehicle occupant shown in FIG. 6 may be a designated passenger. In other embodiments, the designated vehicle occupant shown in FIG. 6 may be another cabin occupant, including a driver when the vehicle is operating in a safe mode for presenting point-of-interest information.

In some embodiments, determining the point of interest is based on the direction in which the designated vehicle occupant's eyes are focusing 601. One or more components of the system are configured to track the designated vehicle occupant's irises and eye alignment to determine a line of sight. The captured eye movement data helps the system identify where the designated vehicle occupant is looking, whether inside the vehicle, such as at information displayed on an infotainment system, or outside the vehicle, such as toward a building, sign, storefront, landmark, roadway feature, or other external object or location.

Alternatively, or additionally, the point of interest is determined based on the orientation of the designated vehicle occupant's face. A camera or other sensor may assess the designated vehicle occupant's head position, facial orientation, or nose direction 602. By correlating the direction of the eyes with the facial orientation, the system determines a gaze vector associated with the designated vehicle occupant.

In an example that combines both eye information 601 and facial orientation 602, the designated vehicle occupant's gaze vector is formulated using combined data on eye direction, iris movement, and head positioning. This integration allows the system to infer the designated vehicle occupant's point of interest. For example, if the designated vehicle occupant's gaze is directed toward a passenger-side window, the system can use that gaze vector, together with vehicle location, vehicle trajectory, and vehicle speed, to identify one or more candidate points of interest outside the vehicle. The gaze analysis may be complemented by contextual data from within the vehicle cabin and other user inputs, such as voice commands or gestures. If the designated vehicle occupant points toward a direction while gazing at a particular area, the system may corroborate the gesture and gaze vector to refine the identified point of interest.

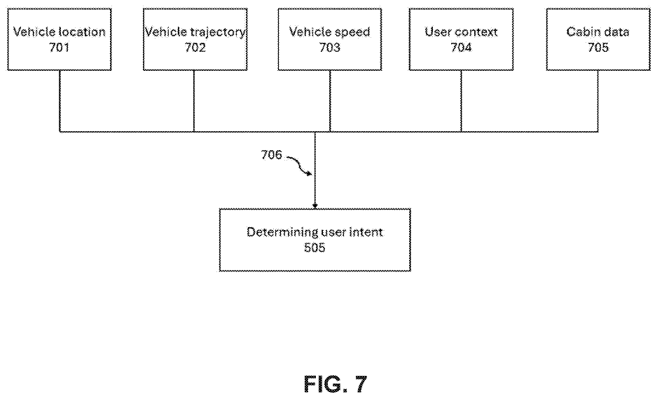

FIG. 7 shows an example of determining user intent based on multiple factors or parameters, as described below:
vehicle location 701 captures the precise geographic location of the vehicle using GPS or similar technologies. The vehicle's position can be used for contextualizing user queries, such as searching for nearby points of interest (POIs) or navigation instructions.
vehicle trajectory 702 includes the vehicle's current path or route, including directional headings and planned destinations. Understanding the trajectory allows the system to predict potential POIs along the route or ahead of the vehicle, enhancing the relevance of suggestions and information provided to the user.
vehicle speed 703 is the velocity at which the vehicle is traveling, and can be used to adjust suggestions dynamically. For instance, slower speeds might indicate urban driving where more frequent stops are acceptable, and a greater number of POIs can be displayed to the passenger. In contrast, higher speeds could suggest highway driving where POIs on direct routes are prioritized, and a fewer number of POIs are displayed.
user context 704 encompasses a broad range of data, including user preferences (e.g., favorite coffee shops or restaurants), historical behavior, and current activities. This personalization ensures that the system's responses are aligned with the individual's known preferences and needs, providing a more tailored user experience.
cabin data 705 from the vehicle's interior includes environmental conditions such as temperature, noise levels, and seat occupancy. For example, recognizing that the user is alone and currently engaged in a conversation can influence the system to provide voice-based responses rather than visual alerts.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and devices can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, these are optional. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed:

1. A method performed by one or more devices within a vehicle, comprising:
receiving a trigger word uttered by a designated passenger in a cabin of the vehicle;
receiving data from within the cabin of the vehicle, wherein the data corresponds to a first duration starting from the trigger word being uttered or a second duration ending with the trigger word being uttered;
determining, subsequent to receiving the trigger word and based on the data, a point of interest indicated by the designated passenger and a request associated with the point of interest;
determining, based on the request, information related to the point of interest; and
providing the information to the designated passenger.

2. The method of claim 1, wherein the vehicle comprises multiple passengers, and wherein the designated passenger is identified from amongst the multiple passengers based on a manual input through a user interface of the vehicle, an autonomous selection based on determining which of the multiple passengers uttered the trigger word, or an autonomous selection based on prior use of the vehicle.

3. The method of claim 1, wherein receiving the trigger word comprises:
receiving an audio signal comprising the trigger word uttered by the designated passenger and at least one interfering signal from within the cabin; and
mitigating a contribution of the at least one interfering signal from the audio signal.

4. The method of claim 3, wherein mitigating the contribution comprises:
determining, based on a distance between a microphone and a seat of the designated passenger, a set of filter coefficients; and
filtering out, using the set of filter coefficients, the at least one interfering signal from the audio signal received by the microphone.

5. The method of claim 1, wherein the data received from within the cabin of the vehicle comprises data corresponding to or associated with the designated passenger, and wherein the data comprises at least one of:
data corresponding to at least one gesture toward an object or a location external to the vehicle;
data corresponding to a gaze vector that is determined based on at least one of a direction in which a designated passenger's eyes are facing, a direction in which a designated passenger's irises are looking, a direction in which a designated passenger's nose is facing, or a direction in which a designated passenger's head is positioned;
data corresponding to speech received in the first duration;
data corresponding to speech, associated with the point of interest or the request, received in the second duration;
data corresponding to a change in the gaze vector; or
data corresponding to a change in the at least one gesture.

6. The method of claim 5, wherein determining the point of interest comprises:
transmitting, to a server, vehicle movement data and the data received from within the cabin, wherein the vehicle movement data includes a location, a trajectory, or a speed of the vehicle; and
receiving, from the server, an identity of the point of interest, wherein the server is configured to identify the point of interest from a database.

7. The method of claim 6, wherein the data comprises the gaze vector, and wherein the server is configured to identify the point of interest based on the location of the vehicle and the gaze vector.

8. The method of claim 7, wherein the point of interest is one of a plurality of adjacent storefronts, and wherein the server is configured to identify the point of interest based on storefront information and vertical physical delineations separating the plurality of adjacent storefronts.

9. The method of claim 6, wherein the server is configured to identify the point of interest based on a context state machine associated with the designated passenger, and wherein the context state machine comprises one or more indications of a utilization, purpose, or type of the vehicle.

10. The method of claim 9, wherein the utilization, purpose, or type comprises a daily commute in a personal vehicle, a non-daily commute in the personal vehicle or a rental vehicle, a business trip in the rental vehicle, or an excursion in the personal vehicle or the rental vehicle.

11. The method of claim 9, wherein determining the request comprises:
receiving, from the server, information related to the request, wherein the request is determined based on the information related to the request, wherein the server is configured to:
process speech by the designated passenger from the first duration or the second duration to generate a textual representation of the speech;
tokenize, based on the one or more indications from the context state machine, the textual representation to generate a tokenized input;
provide the tokenized input for processing by a large language model; and
receive, from the large language model, the information related to the request.

12. The method of claim 7, wherein determining the request comprises:
receiving, from the server, first information related to the request;
determining that a correlation between the first information and the request associated with the point of interest is less than a threshold;
receiving additional data from within the cabin of the vehicle;
transmitting, to the server, at least some of the additional data; and
receiving, from the server, second information related to the request, wherein the request is determined based on the second information upon determining that the correlation between the second information and the request is greater than the threshold.

13. The method of claim 12, wherein determining that the correlation between the first information and the request is less than the threshold comprises at least one of:
receiving, from the server, a low confidence score associated with the first information;
detecting (a) voice stress or (b) keywords indicative of frustration or negative affirmation in speech by a passenger in the vehicle upon providing the first information to the passenger; or
detecting a facial expression of the passenger indicative of frustration or negative affirmation upon providing the first information to the passenger.

14. The method of claim 12, wherein the server is configured, subsequent to receiving the additional data, to:
incorporate the additional data into operations corresponding to a database search, an inference using a large language model, or use of a state machine for contextual data.

15. The method of claim 1, wherein the information comprises a plurality of alternative points of interest from a points of interest database, wherein each alternative point of interest is adjacent to the point of interest or provides similar goods or services as the point of interest.

16. The method of claim 15, wherein a number of the plurality of alternative points of interest is based on the speed of the vehicle, and wherein the number for a first speed is fewer than the number for a second speed that is less than the first speed.

17. The method of claim 1, wherein providing the information comprises:
displaying the information related to the point of interest on a display in the vehicle or on a screen of a device of the designated passenger or another passenger in the vehicle.

18. The method of claim 17, wherein the information comprises reviews, hours of operation, a list of products or services, pricing information, availability information, or reservation information associated with the point of interest.

19. A system for identifying a point of interest from a vehicle, the system comprising:
a microphone configured to receive an audio signal from within a cabin of the vehicle;
one or more cabin sensors configured to generate cabin data associated with a designated vehicle occupant in the cabin of the vehicle;
one or more vehicle-state inputs configured to provide vehicle movement data comprising a location, trajectory, or speed of the vehicle;
a communication interface configured to access a point of interest database, a third-party service, or a remote computing platform; and
one or more processors coupled to one or more memories storing instructions that, when executed by the one or more processors, cause the system to:
detect, from the audio signal, a trigger word uttered by the designated vehicle occupant;
collect the cabin data for a time window associated with the trigger word, wherein the cabin data comprises at least one of a gaze vector, facial orientation, gesture trajectory, speech input, change in gaze vector, or change in gesture trajectory associated with the designated vehicle occupant;
determine a plurality of candidate points of interest based on the vehicle movement data;
dynamically narrow the plurality of candidate points of interest by correlating the cabin data with the vehicle movement data to identify a point of interest indicated by the designated vehicle occupant;
determine, based on speech input associated with the time window, a request associated with the point of interest;
retrieve information related to the point of interest based on the request; and
provide the information to the designated vehicle occupant through a vehicle output device or a user device in the vehicle.

20. The system of claim 19, wherein the one or more processors comprise at least one processor of an embedded vehicle computing system, at least one processor of a user device positioned within the vehicle, or at least one processor of the remote computing platform.
